(19) United States
(12) Patent Application Publication
(10) Pub. No.: US 2002/0081111 A1
(43) Pub. Date: Jun. 27, 2002

(54) Hybrid camera fill-flash

(76) Inventors: Hirohiko Ina, Nishinomiya-shi (JP); Hisanori Hoshikawa, Osaka-shi (JP)

Correspondence Address: Patent Legal Staff, Eastman Kodak Company, 343 State Street, Rochester, NY, 14650-2201, US

(21) Appl. No.: 09/748,620

(22) Filed: Dec. 22, 2000

(51) Int. Cl. G03B 15/03

(52) U.S. Cl. 396/155

(57) ABSTRACT

In a method and camera, a latent image of a subject is captured on a filmstrip during a film exposure time interval. The film exposure time interval has a flash portion and a non-flash portion. The subject is strobe-illuminated during the flash portion. A flash electronic image is captured during the flash portion. A non-flash electronic image is captured during the non-flash portion. The flash and non-flash electronic images are combined to provide a fill-flash electronic image.

### FIELD OF THE INVENTION

The invention relates to photography and cameras and more particularly relates to hybrid electronic-film cameras having fill-flash.

### BACKGROUND OF THE INVENTION

A verifying camera is an electronic-film hybrid that provides an electronic image which accurately mimics the output the user will obtain when the film is processed and printed by a photofinisher. The photographic speeds of the film imaging (silver halide) system and electronic imaging system of a verifying camera are typically not the same. One source of the difference in photographic speeds can be differences in speed of the capture media. The electronic imager in the electronic capture system has the equivalent of a fixed ISO. Photographic film is available in a wide range of film speeds and most reusable cameras can accept photographic films over all or a great part of that range. A minimum range for a camera is typically from ISO 100 to ISO 800. Another source of the difference in optical speeds of the optical systems of the film system and electronic capture system.

One way to accommodate differences in photographic speed is to expose the photographic film and electronic imager for different durations during image capture. This is problematic when an electronic strobe unit (also referred to herein as “flash unit”) is used for subject illumination, since the length or “burn time” of the flash unit needs to be tailored for the capture system requiring a longer exposure, typically the film system. The tailoring is usually done by cutting off the light output of the flash unit after a predetermined time or light exposure. This process is referred to as “quenching”. The illumination provided by the flash unit may be, in some cases, excessive for the electronic imager. A solution to this is cutting off electronic image capture when the exposure is sufficient by physically or electronically shuttering the electronic imager. This processed is sometimes referred to herein as “chopping”. U.S. Pat. Nos. 4, 949,117 and 5,774,750 disclose quenching and chopping in verifying electronic-film hybrid camera.

Fill flash is the use of a flash unit to provide subject lighting that is supplemental to ambient lighting. The flash is intended to provide enough light to fill in the shadows on a subject also illuminated by ambient lighting. Quenching can be used with fill flash to limit the extent of flash illumination added to the ambient illumination. With a hybrid camera this is suitable for the film exposure, but there is a problem for the electronic exposure. If the electronic capture system is opened during the fill-flash strobe illumination and then chopped, the resulting electronic exposure is essentially a flash exposure rather than a fill-flash exposure.

It would thus be desirable to provide an improved hybrid electronic-film camera capable of concurrently capturing both film and electronic fill-flash exposures.

### SUMMARY OF THE INVENTION

The invention is defined by the claims. The invention, in its broader aspects, provides a method and camera in which a latent image of a subject is captured on a filmstrip during a film exposure time interval. The film exposure time interval has a flash portion and a non-flash portion. The subject is strobe-illuminated during the flash portion. A flash electronic image is captured during the flash portion. A non-flash electronic image is captured during the non-flash portion. The flash and non-flash electronic images are combined to provide a fill-flash electronic image.

It is an advantageous effect of the invention that an improved hybrid electronic-film camera is provided which is capable of concurrently capturing both film and electronic fill-flash exposures.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1A is a simplified diagrammatical view of an embodiment of the camera.

FIGS. 1B-1C are each a partial enlargement of the view of FIG. 1A.

FIG. 2 is a front view of the camera of FIG. 1.

FIG. 3 is a partially exploded perspective view of an embodiment of the camera having a modified body shape.

FIG. 4 is a diagrammatical view of the optical system of an alternative embodiment of the camera of FIG. 1.

FIG. 5 is a diagrammatical view of the optical system of an another alternative embodiment of the camera of FIG. 1.

FIG. 6 is a more detailed enlargement of part of the view of FIG. 1 illustrating the controller and related components.

FIG. 7 is a block diagram of the digitally controlled quench flash circuit shown in FIGS. 1 and 6.

FIG. 8 is a circuit diagram of the quench circuit using an external detector.

FIGS. 9 is a block diagram of a camera using image combination techniques.

FIGS. 13A and 13B are a flow chart of an embodiment of the method.

FIG. 14 is a timing diagram of shutter and flash operation in an embodiment of the method which exhibits flash quench and electronic image chop.

FIG. 15 is a timing diagram of another embodiment of the method which exhibits chop, but not quench.

FIG. 16 is a timing diagram of another embodiment of the method which exhibits chop, but not quench, and flash firing at the end of film exposure.

FIG. 17 is a timing diagram of another embodiment of the method in which the flash illumination is quenched and the relative timing of the imager exposure is delayed to reduce the flash illumination received.

FIG. 18 is a timing diagram of another embodiment of the method in which, unlike the methods of FIGS. 14-16, the film requires less light energy than the imager for a unit exposure.

FIG. 19 is a simplified diagrammatical view of another embodiment of the camera.

FIG. 20 is a flow-chart illustrating use of the camera of FIG. 19.

### DETAILED DESCRIPTION OF THE INVENTION

In the camera 10 and method, film and electronic digital images are captured simultaneously using a fill-flash to augment ambient illumination. The electronic image is captured concurrently with the film image under matching illumination and is, thus, usable for verification of what the latent film image will look like after photofinishing. A single flash unit 36 is used (additional flash unit 36s are optional) and is correctly balanced for both film and digital images. The electronic and latent image exposure time intervals can be the same or different. In currently preferred embodiments, the electronic exposure time interval is much shorter than the latent image exposure time interval. Film of different speeds can be used and, in a zoom taking lens embodiment, the available lens apertures can be different at different focal lengths. Balancing of the exposures can be partially provided by varying lens apertures and using fixed or adjustable neutral density filters, but is primarily a function of separately varying the durations of four events: film exposure with flash, film exposure without flash, imager 24 exposure with flash, and imager 24 exposure without flash.

The film exposure with flash illumination is limited by changing the amount of strobe illumination provided while the film shutter 108 is held open. The extent of flash exposure can be conveniently delimited by quenching the flash or timing the flash and shutter movements for incomplete overlap or both. The film exposure without flash illumination is obtained by holding the film shutter 108 open before or after the flash illumination or both.

The imager 24 exposure with flash is delimited by holding the imager shutter 110 closed during part of the flash illumination. This can be provided by “chopping” the imager shutter 110, that is, closing before the end of flash illumination; but is not limited to cutting off the final portion of the flash illumination. For example, the imager shutter 110 can cut off an initial portion of the flash illumination instead. (The terms “chop” and “chopping” are used broadly herein to refer to any event in which the imager shutter 110 is retained in a closed position during part of a flash illumination.) Imager 24 exposure without flash is provided by holding the imager shutter 110 open when flash illumination is not present.

The two imager 24 capture events are, thus, capturing a flash electronic image during a flash portion of a film exposure time interval and capturing a non-flash electronic image during a non-flash portion of a film exposure time interval. The two imager 24 capture events can be separated in time, such that the imager shutter 110 opens and closes twice, or can be continuous with each other, such that the imager shutter 110 opens and closes only once. Separated imager 24 capture events produce two separate electronic images. Those images are each stored in memory and are then added together on a pixel-by-pixel basis to provide a single digital image that corresponds to the concurrently captured latent film image.

It is highly preferred, in order to provide concurrent image capture, that the film exposure with flash is concurrent with the imager 24 exposure with flash, and that the film exposure without flash is concurrent with imager 24 exposure without flash. If this is not done, then the accuracy of the electronic image for verification purposes is degraded.

The camera 10 and method are generally described herein in relation to a combination of film and imager 24, in which the film exposure requires more flash energy than the electronic exposure. The camera 10 and method are inclusive of combinations having the opposite characteristic, the imager 24 requiring more flash exposure than the film. The novel features of the camera 10 and method are usable, but superfluous in situations in which the film and imager 24 require the same exposures.

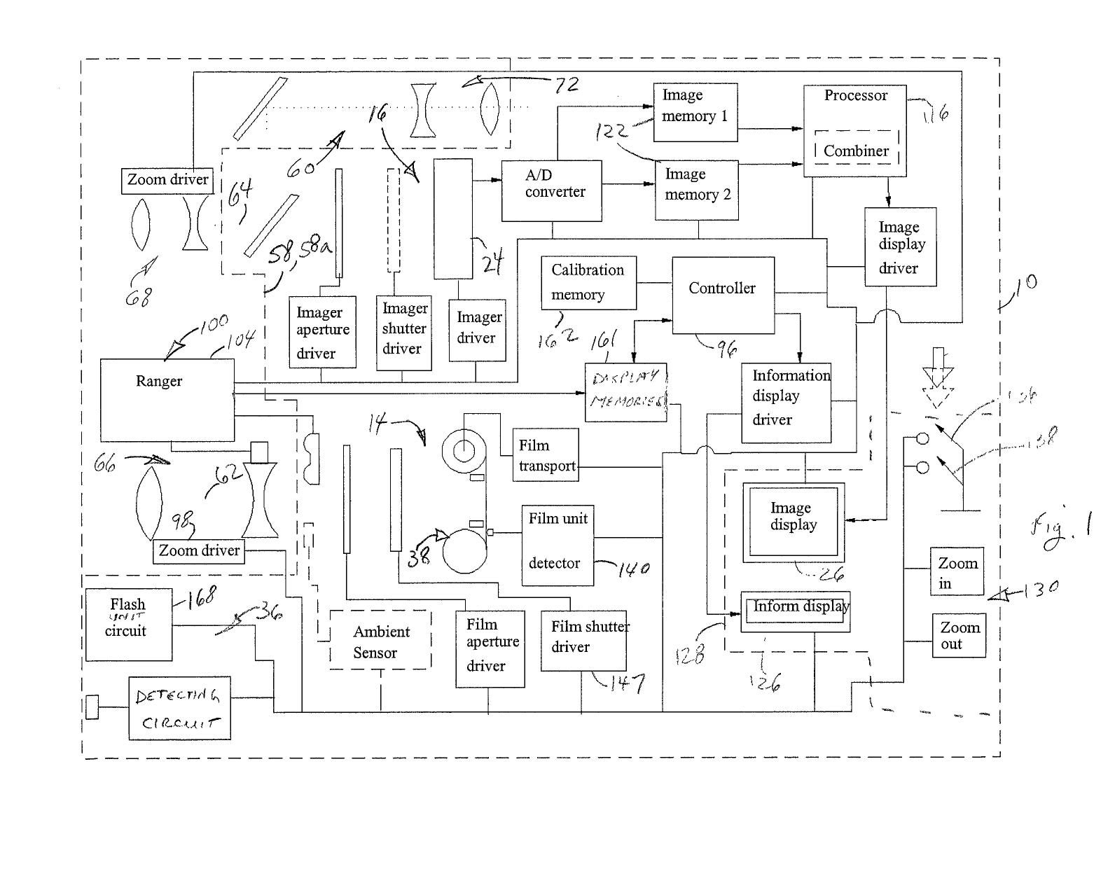

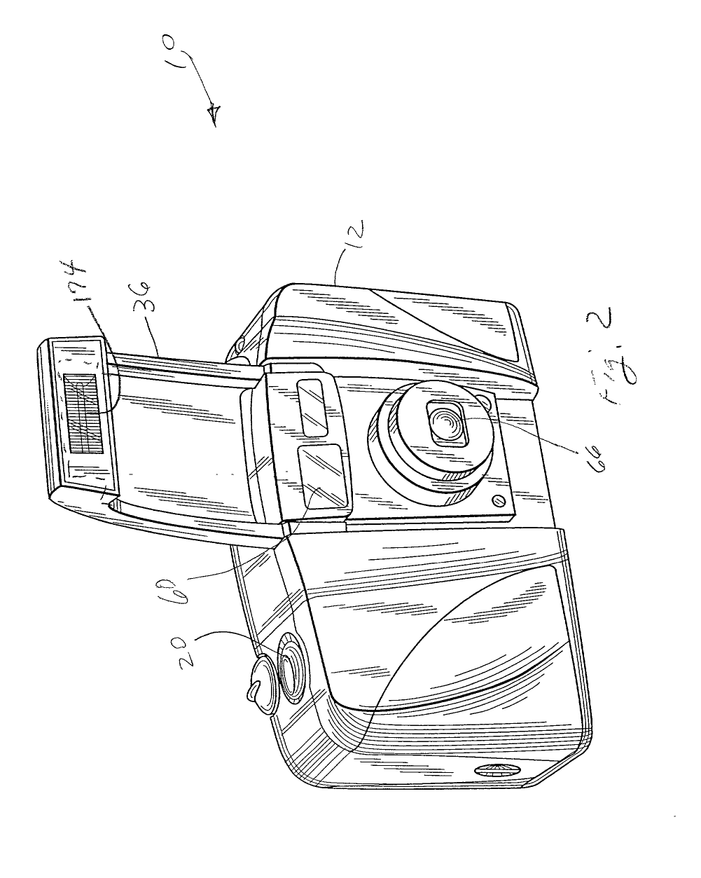

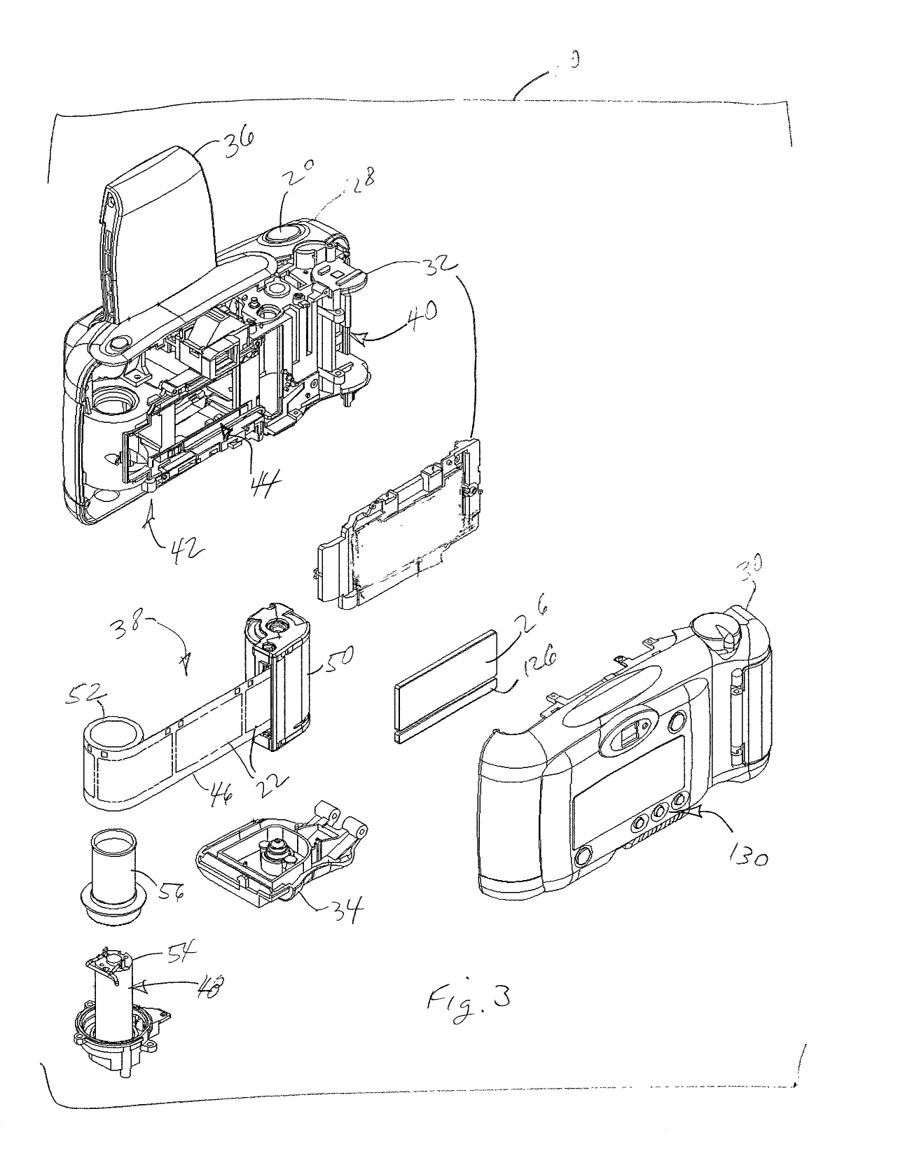

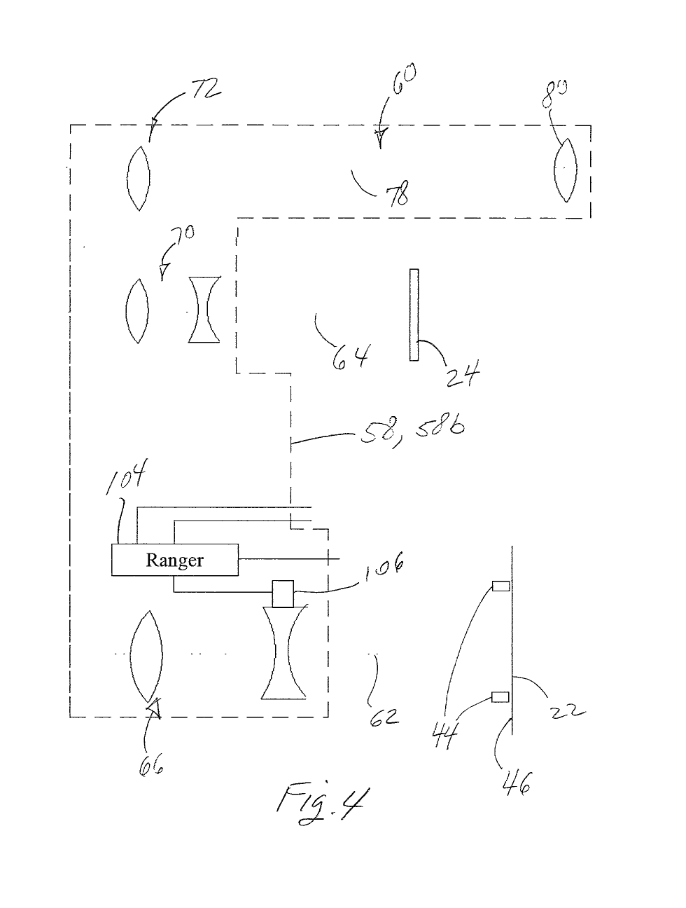

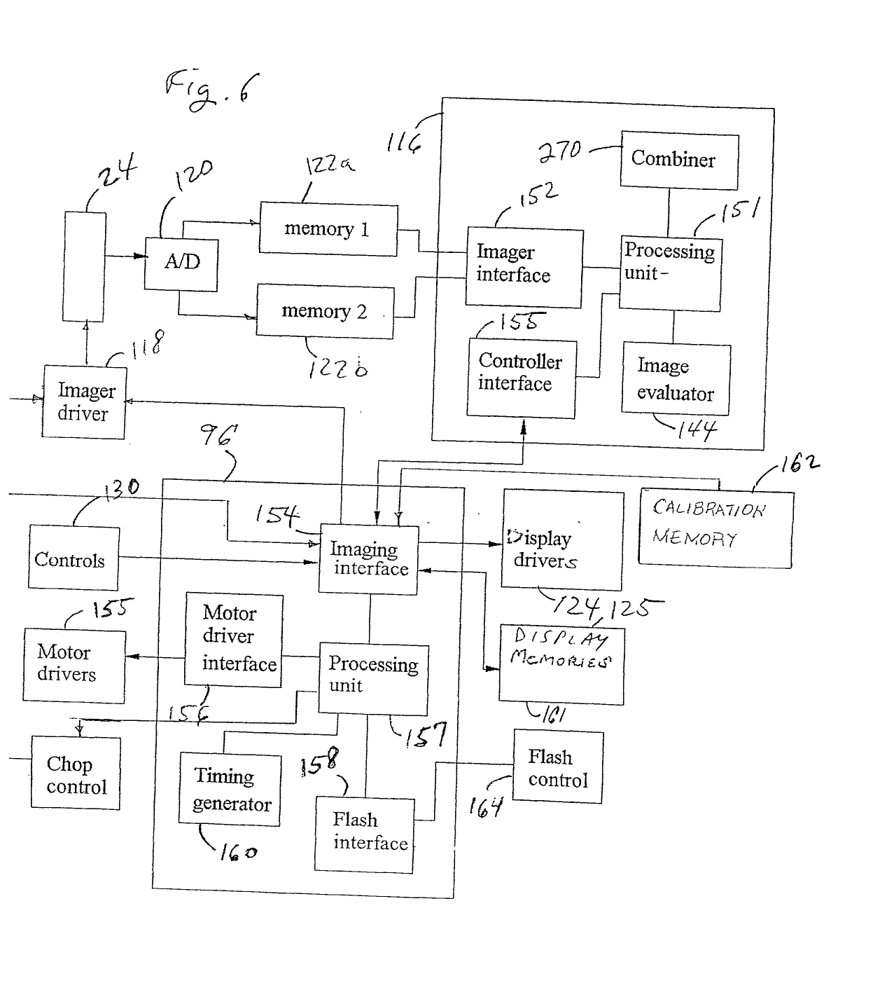

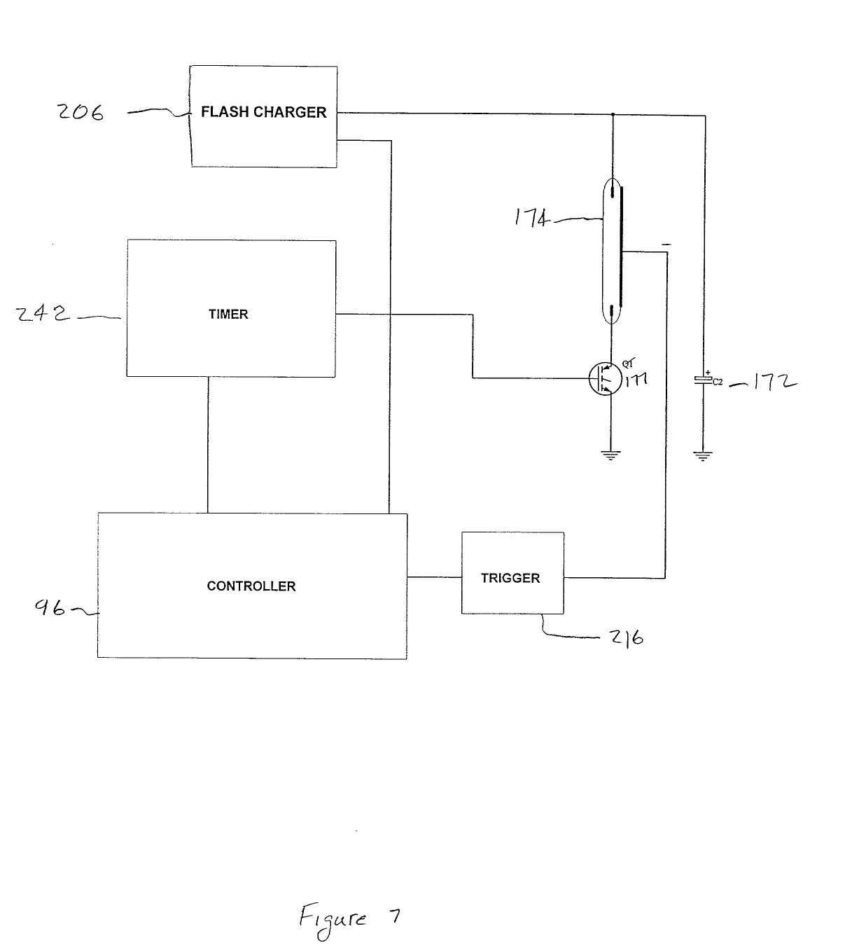

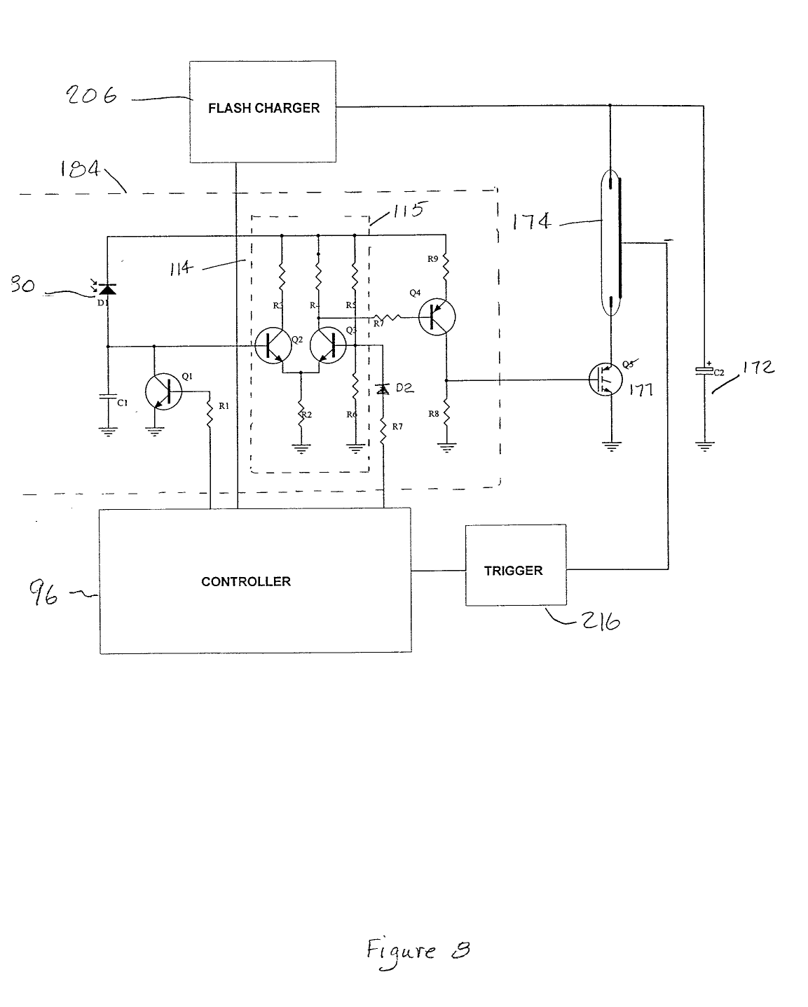

Referring now particularly to FIGS. 1-3, the verifying camera 10 has a body 12 that holds a film latent image capture system 14 and an electronic capture system 16. When the photographer trips (indicated by arrows 18a, 18b) a shutter release 20, a subject image (a light image of the scene) is captured on a film frame 22 (shown in FIG. 3) and on the electronic array imager 24. The electronic image captured on the imager 24, is digitally processed, and a resulting display image is provided on a display 26 mounted to the camera body 12. When fill-flash is used for the film latent image, the verifying image also has a combination of ambient and flash illumination that closely resembles a final image, such as a photographic print, that will be produced by photofinishing the film.

The body 12 of the camera 10 can be varied to meet requirements of a particular use and style considerations. It is convenient if the body 12 has front and rear covers 28, 30 joined together over a chassis 32. Many of the components of the camera 10 can be mounted to the chassis 32. In the embodiment shown in FIGS. 1-3, a film door 34 and a flip-up flash unit 36 are pivotably joined to the covers 28, 30 and chassis 32.

A film unit 38 is used in the camera 10. The type of film unit 38 used is not critical. The embodiment shown in the drawings has an Advanced Photo System (“APS”) film cartridge 38. This is not limiting. For example, other types of one or two chamber film cartridge 38, and roll film can also be used.

It is currently preferred that the camera 10 be reloadable by the user, but the camera 10 can be configured for one-time use. The chassis 32 defines a film cartridge 38 chamber 40, a film supply chamber 42, and an exposure frame 44 between the chambers 40, 42. A filmstrip 46 is moved by a film transport 48 out of the canister 50 of the film cartridge 38, is wound into a film roll 52 in the supply chamber 42, and is then returned to the canister 50. The film transport 48, as illustrated in FIG. 3, includes an electric motor 54 located within a supply spool 56, but other types of motorized transport mechanisms and manual transports can also be used. Latent image exposure can be on film advance or on rewind.

The electronic array imager 24 is mounted in the body 12 and is configured so as to capture the same scene as is captured in the latent image. The type of imager 24 used in vary, but it is highly preferred that the imager 24 be one of the several solid-state imagers available. One highly popular type of solid-state imager commonly used is the charge coupled device (“CCD”). Of the several CCD types available, two allow easy electronic shuttering and thereby are preferable in this use. The first of these, the frame transfer CCD, allows charge generation due to photoactivity and then shifts all of the image charge into a light shielded, non-photosensitive area. This area is then clocked out to provide a sampled electronic image. The second type, the interline transfer CCD, also performs shuttering by shifting the charge, but shifts charge to an area above or below each image line so that there are as many storage areas as there are imaging lines. The storage lines are then shifted out in an appropriate manner. Each of these CCD imagers has both advantages and disadvantages, but all will work in this application. It is also possible to use an electronic image sensor manufactured with CMOS technology. This type of imager is attractive for use, since it is manufactured easily in a readily available solid-state process and lends itself to use with a single power supply. In addition, the process allows peripheral circuitry to be integrated onto the same semiconductor die. A third type of sensor which can be used is a charge injection device (CID). This sensor differs from the others mentioned in that the charge is not shifted out of the device to be read. Reading is accomplished by shifting charge within the pixel. This allows a nondestructive read of any pixel in the array. If the device is externally shuttered, the array can be read repeatedly without destroying the image. Shuttering can be accomplished by external shutter or, without an external shutter, by injecting the charge into the substrate for recombination.

Referring now primarily to FIGS. 1 and 4-5, the camera 10 has an optical system 58 that directs light to the exposure frame 44 and to the electronic array imager 24. The optical system 58 also preferably directs light through a viewfinder 60 to the user, as shown in FIGS. 1 and 4-5. The imager 24 is spaced from the exposure frame 44, thus, the optical system 58 directs light along the first path (indicated by a dotted line 62) to the exposure frame 44 and along a second path (indicated by a dotted line 64) to the electronic array imager 24.

Both paths 62, 64 converge at a position in front of the camera 10, at the plane of focus of the subject image.

The optical system 58 can be varied. In FIG. 1, the optical system 58 a has first and second paths 62, 64, are in convergence at the subject image and extend to a taking lens unit 66 and a combined lens unit 68 that includes both an imager lens unit 70 and a viewfinder lens unit 72. The combined lens unit 68 has a partially transmissive mirror 74 that subdivides the second light path 64 between an imager subpath 76 to the imager 24 and a viewfinder subpath 78 that is redirected by a fully reflective mirror 75 and transmitted through an eyepiece 80 to the photographer. In an alternative optical system 58b shown in FIG. 4, a viewfinder lens unit 72 and an imager lens unit 70 provided in the second path 64 and a third path 78, respectively, are fully separate. In an alternative shown in FIG. 5, the optical system 58c has a combined lens unit 68 that includes both a taking lens unit 66 and an imager lens unit 70. In this case, a partially transmissive mirror 74 subdivides the first light path between a film subpath 88 to the film exposure frame 44 and an imager subpath 76 to the imager 24. A fully reflective mirror 75 is positioned to redirect light along the imager subpath 76. The viewfinder lens unit 72 is separate. Other alternative optical systems 58 can also be provided.

With a verifying camera 10, the verifying image does not have to have the same quality as the latent image captured on film. As a result the imager 24 and the portion of the optical system 58 directing light to the imager 24 can be made smaller, simpler, and lighter. For example, the taking lens unit 66 can be focusable and the imager lens unit 70 can have a fixed focus or can focus over a different range or between a smaller number of focus positions.

Referring now to the embodiment shown in FIG. 1, the taking lens unit 66 is a motorized zoom lens in which a mobile element or elements 90 are driven, relative to a stationary element or elements 92, by a zoom driver 94. The combined lens unit 68 also has a mobile element or elements 90 driven, relative to a stationary element or elements 92, by a zoom driver 94. The different zoom drivers 94 are coupled so as to zoom to the same extent, either mechanically (not shown) or by a controller 96 signalling the zoom drivers 94 to move the zoom elements 90 of the unit 66 and unit 68 over the same range of focal lengths at the same time (symbolized by double-headed arrows 98 in FIG. 1). The controller 96 can take the form of an appropriately configured microcomputer, such as an embedded microprocessor having RAM for data manipulation and general program execution.

The taking lens unit 66 of the embodiment of FIG. 1 is also autofocusing. An autofocusing system 100 has a sensor 102 that sends a signal to a ranger 104, which then operates a focus driver 106 to move one or more focusable elements (not separately illustrated) of the taking lens unit 66. The type of autofocusing system 100 used is not critical. The autofocus 100 can be passive or active or a combination of the two.

The taking lens unit 66 can be simple, such as having a single focal length and manual focusing or a fixed focus, but this is not preferred. The viewfinder lens unit 72 and imager lens unit 70 in some of the embodiments, have a fixed focal length. These units 70, 72 can zoom instead and digital zooming can also be used instead of or in combination with optical zooming for the imager 24. The imager 24 and display 26 can be used as a viewfinder 60 prior to image capture in place of or in combination with the optical viewfinder 60, as is commonly done with digital still cameras. This approach is not currently preferred, since battery usage is greatly increased.

A film shutter 108 shutters the light path to the exposure frame 44. An imager shutter 110 shutters the light path to the imager 24. Diaphragms/aperture plates 112, 113 can also be provided in both of the paths. Each of the shutters 108, 110 is switchable between an open state and a closed state. The term “shutter” is used in a broad sense to refer to physical and/or logical elements that provide the function of allowing the passage of light along a light path to a filmstrip 46 or imager 24 for image capture and disallowing that passage at other times. “Shutter” is thus inclusive of, but not limited to, mechanical and electromechanical shutters of all types. “Shutter” is not inclusive of film transports and like mechanisms that simply move film or an imager in and out of the light path. “Shutter” is inclusive of computer software and hardware features of electronic array imagers 24 that allow an imaging operation to be started and stopped under control of the camera controller 96.

In currently preferred embodiments, the film shutter 108 is mechanical or electromechanical and the imager shutter 110 is mechanical or electronic. The imager shutter 110 is illustrated by dashed lines in FIG. 1 to indicate both the position of a mechanical imager shutter and the function of an electronic shutter. When using a CCD, electronic shuttering of the imager can be provided by shifting the accumulated charge under a light shielded provides at a non-photosensitive region. This may be a full frame as in a frame transfer device CCD or a horizontal line in an interline transfer device CCD. Suitable devices and procedures are well known to those of skill in the art. When using a CID, the charge on each pixel is injected into a substrate at the beginning of the exposure. At the end of the exposure, the charge in each pixel is read. The difficulty encountered here is that the first pixel read has less exposure time than the last pixel read. The amount of difference is the time required to read the entire array. This may or may not be significant depending upon the total exposure time and the maximum time needed to read the entire array. CMOS imagers are commonly shuttered by a method called a rolling shutter. CMOS imagers using this method are not preferred, since this shutters each individual line to a common shutter time, but the exposure time for each line begins sequentially. This means that even with a short exposure time, moving objects will be distorted. Given horizontal motion, vertical features will image diagonally due to the temporal differences in the line-by-line exposure. Another method for shuttering CMOS imagers is described in U.S. Pat. No. 5,966,297. In this method, called single frame capture mode, all pixels are allowed to integrate charge during exposure time. At the end of the exposure time, all pixels are simultaneously transferred to the floating diffusion of the device. At this point sequential read out by lines is possible.

Referring now particularly to FIGS. 1 and 6-12B, signal lines 114 electronically connect the imager 24, the controller 96, a processor 116, other electronic components, and the image display 26. The imager 24 receives a light image (the subject image) and converts the light image to an analog electrical signal, the initial electronic image. (For convenience, the electronic image is generally discussed herein in the singular.) The electronic imager 24 is operated by the imager driver 118. The initial electronic image is amplified and converted by an analog to digital (A/D) converter-amplifier 120 to a digital electronic image, which is then processed and stored in an image memory 122. “Memory” refers to a suitably sized logical unit of physical memory provided in semiconductor memory or magnetic memory, or the like. The electronic images are accessed and modified by the processor 116, as necessary to meet predetermined output requirements, such as calibration to the display used, and are output to the display. The display 26 is driven by a display driver 124 and using the output of the processor 116 produces a display image that is viewed by the user. The controller 96 facilitates the transfers of the electronic image between the electronic components and provides other control functions, as necessary. The controller 96 can be provided as a single component or as multiple components of equivalent function in distributed locations. The same considerations apply to the processor 116 and other components. Likewise, components illustrated as separate units herein may be conveniently combined or shared in some embodiments.

The type of image display 26 used is not critical. For example, the display 26 can be a liquid crystal display, a cathode ray tube display, or an organic electro-luminescent display (“OELD”; also referred to as an organic light emitting display, “OLED”). Displays having low power requirements are preferred. It is also preferred that the image display 26 is operated on demand by actuation of a switch (not separately illustrated) and that the image display 26 is turned off by a timer or by initial depression of the shutter release 20. The timer can be provided as a function of the controller 96.

The display 26 is preferably mounted on the back or top of the body 12, so as to be readily viewable by the photographer immediately following a picture taking. One or more information displays 126 can be provided on the body 12, in addition to display 26, to present camera information to the photographer, such as exposures remaining, battery state, printing format (such as C, H, or P), flash state, and the like. This information can also be provided on the image display 26 as a superimposition on the image or alternately instead of the image.

The image display 26 is shown in FIG. 3 mounted to the back of the body 12. An information display 126 is mounted to the body 12 adjacent the image display 26 so that the two displays 26, 126 form a single user interface 128 that can be viewed by the photographer in a single glance. As with information displays 126, the image display 26 can be mounted instead or additionally so as to be viewable through the viewfinder 60 as a virtual display 26. The image display 26 can also be used instead of or in addition to an optical viewfinder 60.

It is preferred that the imager 24 captures and the image display 26 shows substantially the same geometric extent of the subject image as the latent image, since the photographer can verify only what is shown in the display 26. For this reason it is preferred that the display 26 show from 85-100 percent of the latent image, or more preferably from 95-100 percent of the latent image.

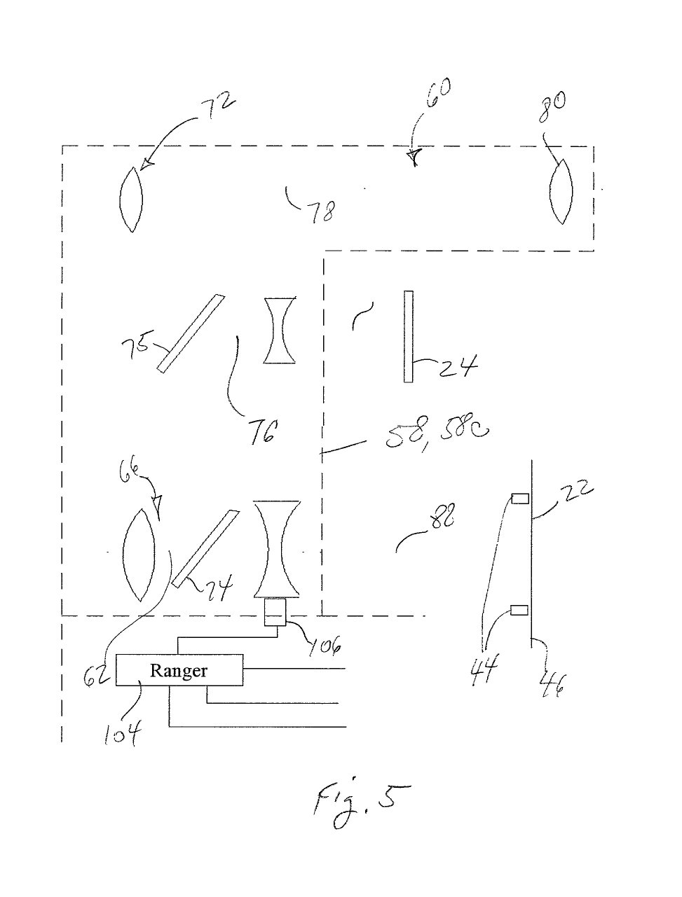

Referring now particularly to FIG. 1, the camera 10 has user controls 130 including “zoom in” and “zoom out” buttons 132, 134 that control the zooming of the lens units, and the shutter release 20. The shutter release 20 operates both shutters 108, 110. To take a picture, the shutter release 20 is actuated by the user and trips from a set state to an intermediate state, and then to a released state. The shutter release 20 is typically actuated by pushing, and, for convenience the shutter release 20 is generally described herein in relation to a shutter button that is initially depressed through a “first stroke” (indicated in FIG. 1 by a solid lined arrow), to actuate a first switch 136 and alter the shutter release 20 from the set state to the intermediate state and is further depressed through a “second stroke” (indicated in FIG. 2 by a dashed lined arrow), to actuate a second switch 138 and alter the shutter release 20 from the intermediate state to the released state. Like other two stroke shutter releases well known in the art, the first stroke actuates automatic setting of exposure parameters, such as autofocus, autoexposure, and flash unit readying; and the second stroke actuates image capture.

Referring now to FIGS. 1 and 6, when the shutter release 20 is pressed to the first stroke, the taking lens unit 66 and combined lens unit 68 are each autofocused to a detected subject distance based on subject distance data sent by the autoranging unit (“ranger” in FIG. 1) to the controller 96. The controller 96 also receives data indicating what focal length the zoom lens units 66, 68 are set at from one or both of the zoom drivers 94 or a zoom sensor (not shown). The camera 10 also detects the film speed of the film cartridge 38 loaded into the camera 10 using a film unit detector 140 and relays this information to the controller 96. The camera 10 obtains scene brightness (Bv) from components that function as a light meter. The scene brightness and other exposure parameters are provided to an algorithm in a control processor 145, which determines a focused distance, shutter speeds, apertures, and optionally a gain setting for amplification of the analog signal provided by the imager. Appropriate signals for these values are sent to the focus driver 106, film and imager aperture drivers 146, 148, and film and imager shutter drivers 147, 149; via a motor driver interface 150 of the controller 96. The gain setting is sent to the A/D converter-amplifier 120.

In one embodiment, scene brightness is determined from an evaluation of exposure data provided by a separate ambient sensor 142 and connected ambient sensor driver 143 (indicated by dashed lines in FIG. 1). In another embodiment, the ambient sensor is not present and the electronic capture system 16 is used instead to obtain scene brightness values. In that embodiment, the electronic capture system 16 has an evaluation mode and a capture mode.

In the evaluation mode, the electronic capture system 16 captures one or more electronic images while the first switch 136 is actuated and the second switch 138 is not. The evaluation mode electronic images are processed by an image evaluator 144 of the processor 116 to provide exposure parameters that are used in automatic exposure operations. The electronic capture system 16 is calibrated during assembly, to provide a measure of illumination levels, using a known illumination level and imager gain.

The processing, in the evaluation mode, is like that of other electronic images discussed in detail below, with the exception that once the illumination data is read into memory, the evaluator 144 processes the data using the same kinds of algorithms as are used for multiple spot light meters. Individual pixels or groups of pixels take the place of the individual sensors used in the multiple spot light meters. For example, the evaluator can determine a peak illumination intensity for the image by comparing pixel to pixel until a maximum is found. Similarly, the evaluator can determine an overall intensity that is an arithmetic average of all of the pixels of the image. Many of the algorithms provide an average or integrated value over only a portion of the imager array. Another approach is to evaluate multiple areas and weigh the areas differently to provide an overall value. For example, in a center weighted system, center pixels are weighted more than peripheral pixels. The camera can provide manual switching between different approaches, such as center weighted and spot metering. The camera can alternatively, automatically choose a metering approach based on an evaluation of scene content. For example, an image having a broad horizontal bright area at the top can be interpreted as sky and given a particular weight relative to the remainder of the image.

Under moderate lighting conditions the imager can provide light metering from a single image capture. More extreme lighting conditions can be accommodated by repeating electronic image capture events while varying exposure parameters until an acceptable electronic image for light metering has been captured. The manner in which the parameters are varied is not critical. The following approach is convenient. When an unknown scene is to be measured, the imager is set to an intermediate gain and the image area of interest is sampled. If the pixels measure above some upper threshold value (T_{H}) such as 220, an assumption is made that the gain is too high and a second measurement is made with a gain of one-half of the initial measurement (1 stop less). (The values for T_{H} and T_{L} given here are by way of example and are based on 8 bits per pixel or a maximum numeric value of 255.) If the second measurement is one-half of the previous measurement, it is assumed that the measurement is accurate and representative. If the second measurement is still above Tₕ, the process is repeated until a measurement is obtained that has a value that is one-half that of the preceding measurement. If the initial measurement results in a value less than a low threshold (T_{L}) such as 45, the gain is doubled and a second measurement made. If the resultant measurement is twice the first measurement, it is assumed that the measurement is accurate and representative. If this is not the case, then the gain is doubled again and the measurement is repeated in the same manner as for the high threshold. Exposure parameters, such as aperture settings and shutter speeds can be varied in the same manner, separately or in combination with changes in gain. In limiting cases, such as full darkness, the electronic image capture system is unable to capture an acceptable image. In these cases, the evaluator can provide a metering failure signal to the user interface to inform the user that the camera cannot provide appropriate light metering under the existing conditions. Appropriate algorithms and features for these approaches are well known to those of skill in the art.

After the controller 96 receives the scene brightness value, the controller 96 next compares scene brightness to a full flash trip point. If the light level is lower than the flash trip point, then the camera 10 will enable full illumination by the flash unit 36, unless the user manually turned the flash off. If the light level is above the flash trip point, then the camera 10 will select ambient illumination or fill flash augmentation of ambient illumination. For the full flash case, the controller 96 determines the appropriate flash exposure times for both the film and electronic images. For the fill flash case, the controller 96 determines both ambient and flash exposure times for the film exposure 22 and for the electronic exposure 24. These may also be referred to as the “film nonflash exposure time”, the “film flash exposure time”, the “imager non-flash exposure time”, and the “imager flash exposure time”. When the user depresses the shutter release 20 through the second stroke, the second switch 138 closes and enables both a film image and an electronic image to be captured.

Referring now to the embodiment shown in FIGS. 6-12B, the captured image data is passed through the A/D converter-amplifier 120 directly or through memory 122 to the processor 116. The image data enters the processor 116 via an imager interface 152 in the processor 116, and is processed in a processing unit 151. The electronic image is stored in one or more image memories 122 as necessary. The image evaluator 144 samples the image data of the electronic image and determines scene parameters, which are sent to the controller via a controller interface 155 of the processor 116 and an imaging interface 154 of the controller 96.

The controller 96 has a processing unit 157. The controller 96 includes a timing generator 160 that supplies control signals for all electronic components in timing relationship to the controller processing unit 157. The controller 96 has several interfaces. Signals from the camera controls 130 are supplied via the imaging interface 154 of the controller 96. Calibration values for the individual camera 10 are stored in a calibration memory 162, such as an EEPROM, and supplied to the processing unit 157 via the imaging interface 154. The information display driver 124 and image display driver 125 and display memories 161 are controlled through the imaging interface 154.

Referring now to FIG. 1A and FIG. 6, the zoom drivers 98, focus driver 106, film and imager aperture drivers 146, 148, and film and imager shutter drivers 147, 149 (indicated collectively in FIG. 6 as “motor drivers 155”) are all controlled via a motor driver interface 156 of the controller 96. The controller 96 has a flash interface 158 that connects to a flash control 164 that mediates flash functions. The controller 96 also controls electronic imager shutter times. It will be understood that the circuits shown and described can be modified in a variety of ways well known to those of skill in the art. For example, the flash control and chop control can be integrated into the controller and the processor and controller can share a single processing unit. It will also be understood that the various features described here in terms of physical circuits can be alternatively provided as firmware or software functions or a combination of the two.

The flash unit 36 of the camera 10 has a flash unit circuit 168, into which a flash activation signal is sent when the film shutter 108 is operated. The flash unit 36 is shown incorporated in the body 12 of the camera 10, but comparable features can be provided for a camera having an external strobe unit. The duration of the flash provided can be controlled by timing or measurement of light reflected off the subject or some combination of the two. The embodiment of the camera 10 shown in FIG. 1 can provide any of these modes, however, the timing is preferred over light measurement, for reasons of accuracy and simplicity. The camera 10 can be configured so as to be limited to a particular mode, if desired.

Referring now to FIG. 8 which shows a preferred method of quench. This controller 96 determines a time and that time is then loaded into the timer 242. The controller 96 ascertains that the storage capacitor C2 is fully charged. If not, the flash charger 206 is turned on and the shutters are locked. When the capacitor is charged, the controller 96 releases the shutters via the shutter drivers. The flash is fired via the trigger circuitry 216 and the timer is started. The flash tube 174 conducts through the quench transistor 177. This is typically an insulated gate bi-polar transistor (IGBT). To insure conduction through the transistor 177, the timer 242 holds the gate of the transistor high. When the correct time has elapsed, the gate is taken low by the timer 242 and transistor 177 is turned off. The flash quench process begins with the operator actuating the shutter release 20, which asserts a signal on a shutter line 220 that is applied to the input of the flash control circuit 164. The flash_time register/counter 242 controls the flash time according to the flash_time signal coming from the flash interface 158. If the maximum flash time is reached, the flash is quenched. In the timed flash mode, the subject distance is known, and the amount of flash is a predetermined value. The subject distance is preferably determined automatically from the lens autofocus algorithm, or alternately can be manually input by the user. Reflected light measurement can be used in the timed flash mode to cut off the flash if light reflection from the photographic subject exceeds a predetermined expected value for a particular flash duration.

An alternative method of quench is shown in FIG. 8. In this embodiment the controller 96, in response to inputs of scene brightness and subject distance calculates the correct flash exposure level for the film portion of the camera. The controller ascertains that the storage capacitor 172 is fully charged. If it is not, the flash charger 206 is turned on. When the capacitor is charged the controller 96 releases the shutters via the drivers. The flash is fired via the trigger circuitry 216. A flash integrator is formed from a photo-diode 180 and a capacitor C1. Q1 has been in the conducting state so that no charge has accumulated in C1. Upon flash initiation Q1 is turned off. This allows accumulated charge to show as a voltage on C1. This voltage is fed to a schmitt trigger 115. Within the schmitt trigger Q3 is conducting. This turns on Q4 that allows the IGBT 177 to be conducting. As the voltage on C1 increases, it eventually reaches a point that causes Q2 to conduct. This causes Q3 to go out of conduction since R3 is a smaller value than R4. When Q3 turns off, Q4 turns off and transistor 177 turns off stopping the flash. The controller 96 controls flash level by passing current through R7. This controls the turn off point of the schmitt trigger 115. More current through R7 raises the trigger point and requires more flash energy before the quench takes place.

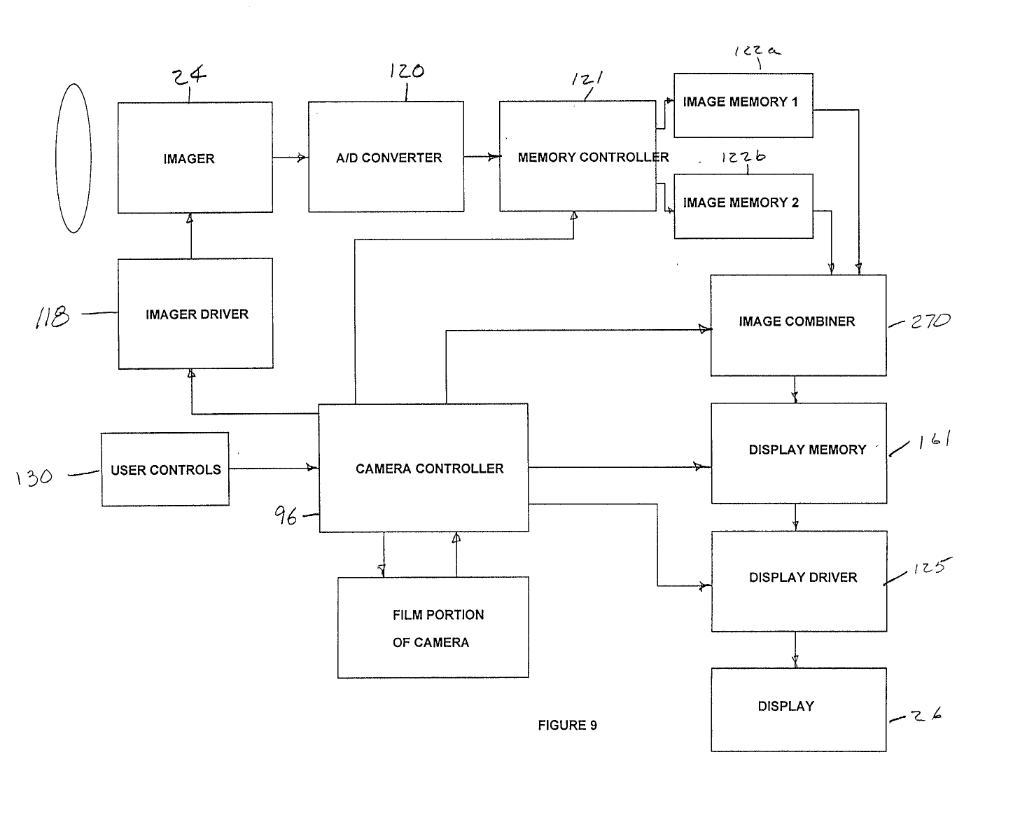

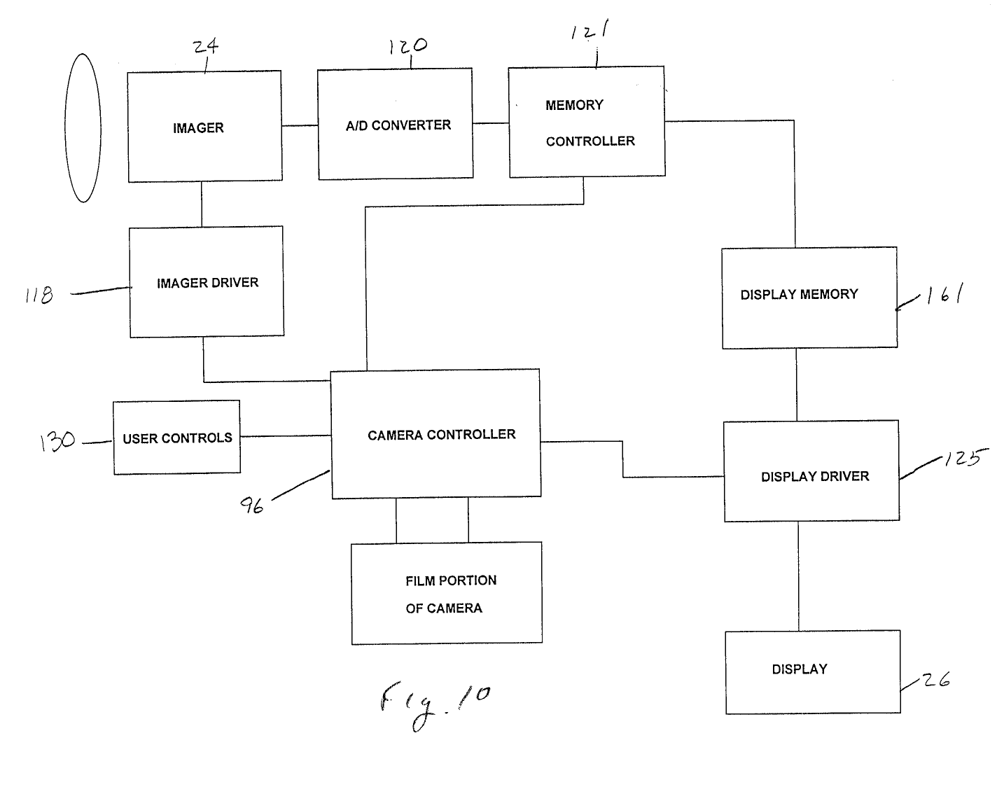

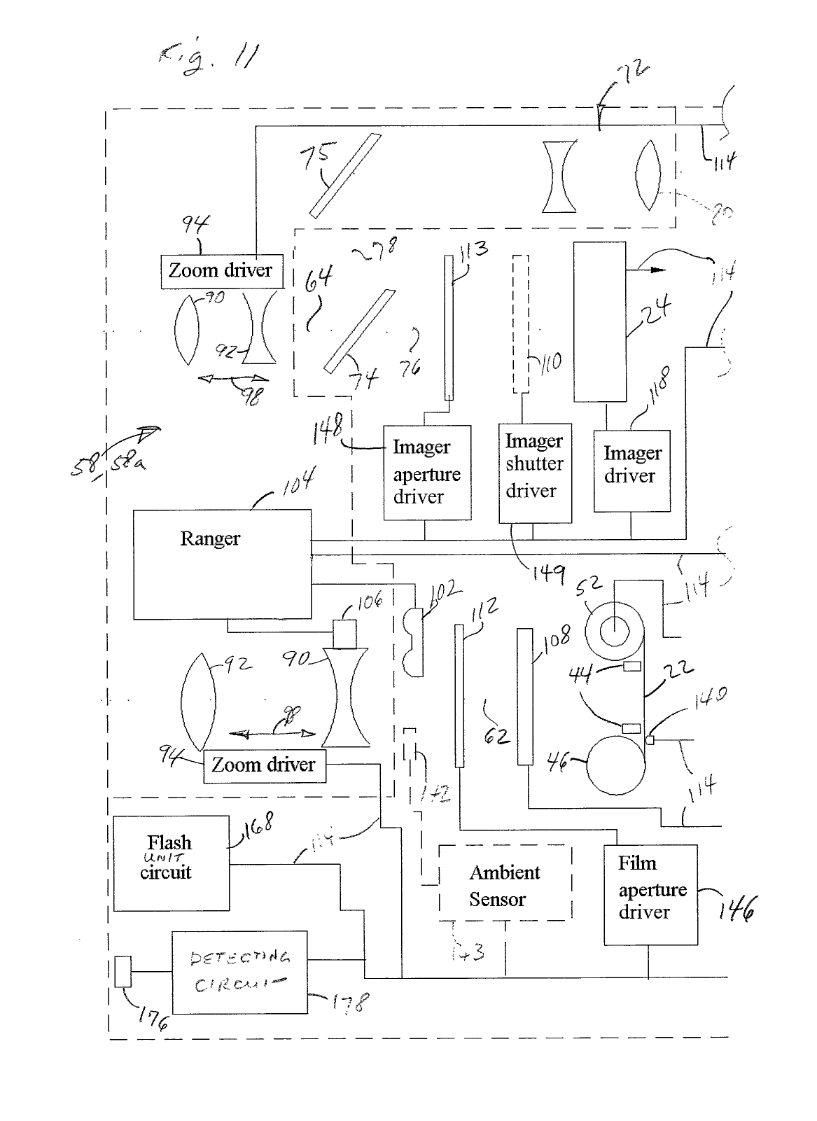

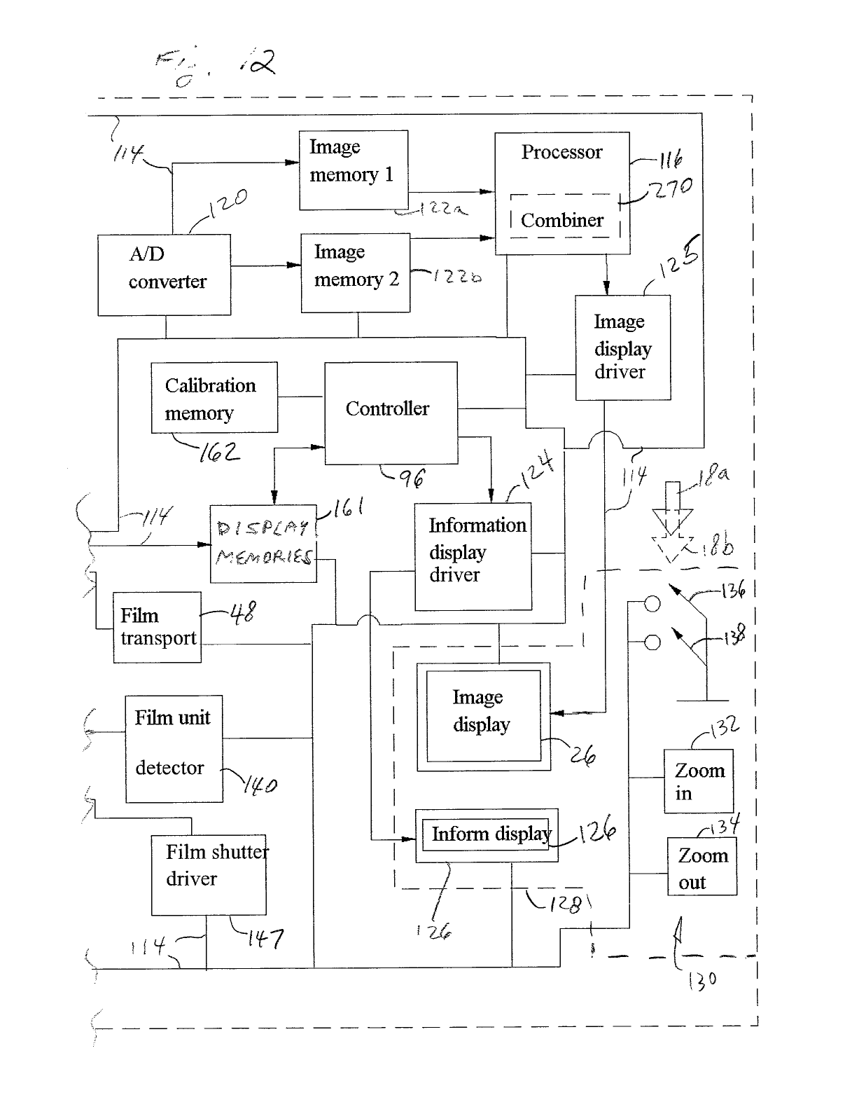

Referring now to FIGS. 9, the operation of the chop will be discussed. As shown previously, the flash duration or flash level is computed based on film speed, subject distance, and ambient lighting conditions. Since the electronic imaging system uses a different lens and has an imager with an equivalent speed which is different from the film, the amount of fill flash needed for an accurate representation of the film image will likely be different from that needed for the film exposure. In making the film exposure, we fired the flash circuit at the beginning of the film exposure, but held the shutter open for an extended period of time after the flash had been quenched. The camera controller 96 calculated the time of the flash as well as the time for the shutter opening. The camera controller 96 calculates an electronic flash time and an electronic ambient shutter time. In the embodiment shown in FIG. 9, the camera controller 96 causes the imager driver 118 to cause the imager 24 to make an initial exposure during the period of the flash. This image is sent to the A/D converter 120 in which it is converted into a digital image which is then stored in image memory 1 122a. During the time of the film ambient light exposure, the camera controller 96 causes the imager 24 to make a second exposure for a previously calculated time. At the end of this exposure period, the image is once again converted to a digital image and that second image is stored in image memory 2 122b. The two images are combined within the image combiner 270. The combined image is moved to the display memory 161. Upon command from the user controls, the camera controller 96 causes the display driver 125 in conjunction with the display memory 161 to display the resultant image on the display 26. The film is now advanced and the camera is ready for the next exposure.

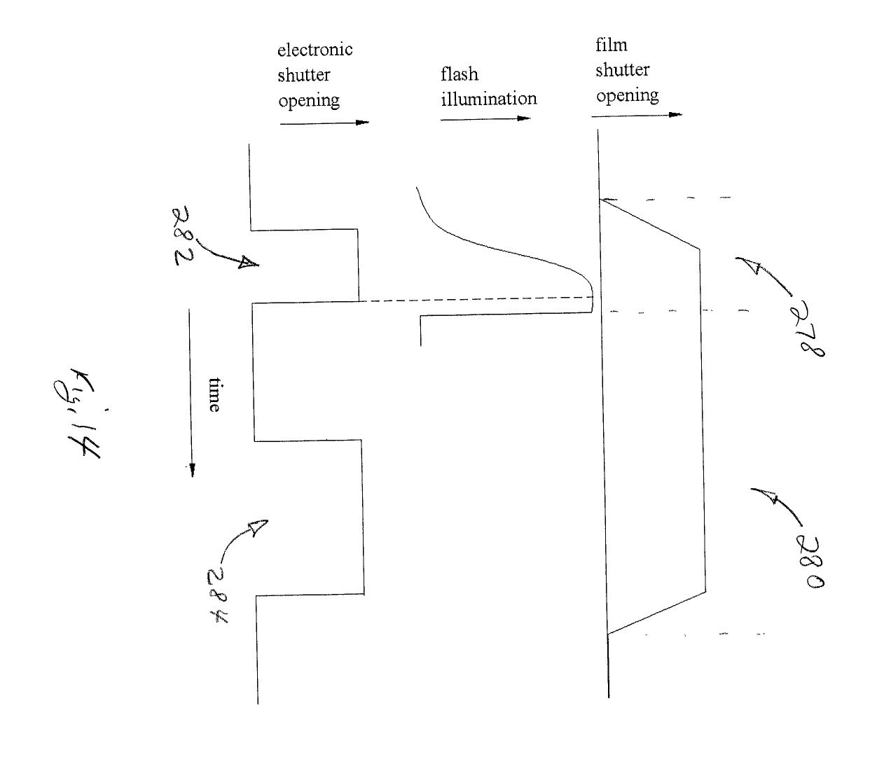

FIG. 14, 15, & 16 show the relationship of the film shutter opening, the flash duration, the electronic image flash exposure, and the electronic image ambient exposure. This method of providing an accurate reproduction of the film image during fill flash operation is unusable when an external sensor is used to determine correct film flash exposure. This is because the total length of the flash duration is not known. As a result, we will calculate the electronic flash time needed and make this exposure at the beginning of flash time. As will be seen, other methods of providing the balance between exposures for film and electronics may not allow adapt as well for an externally sensed quench level.

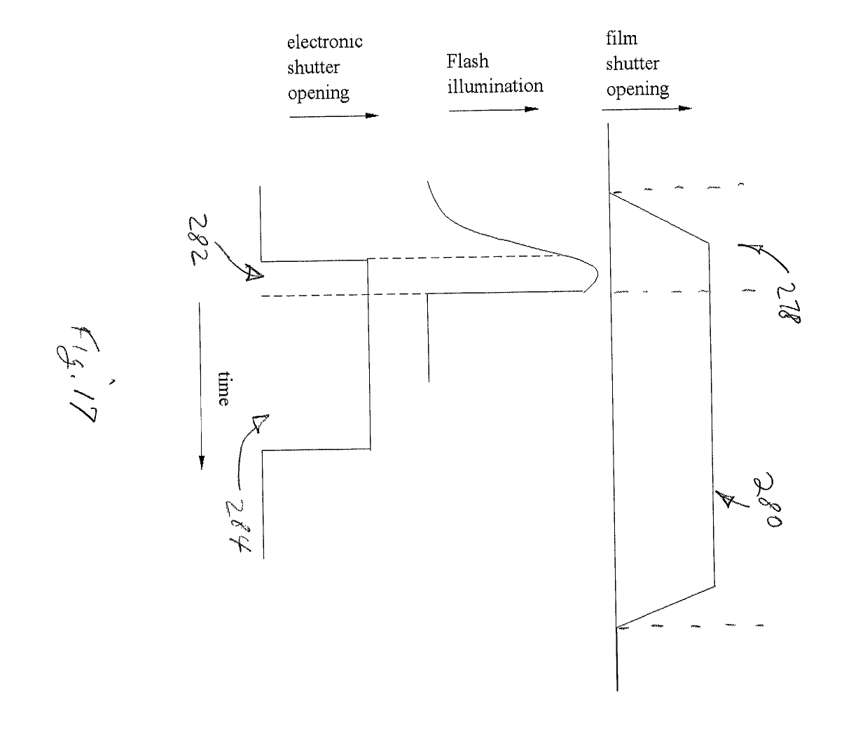

Another method providing the needed balance between the film exposure and the electronic exposure is shown in FIG. 11 and FIG. 17. In this embodiment, the camera controller 96 determines the correct ambient exposure time and flash exposure time for the film system. It also determines the correct flash and ambient exposure time for the electronic system. The film shutter is opened and the flash is fired. When the time difference between the film flash time and the electronic flash time is reached, the electronic exposure is started. The flash system quenches, the electronic ambient exposure continues until the correct value is reached. The electronic exposure is terminated. The image data is transferred to the A/D converter 120, through the memory controller (mm) to the display memory 161. When the correct film exposure is complete, the shutter is closed. The camera controller 96 now enables the display driver 125 and the image may be displayed upon the display 26. Film is advanced in the camera and the user can now take another picture. The exposure sequence is shown in FIG. 12.

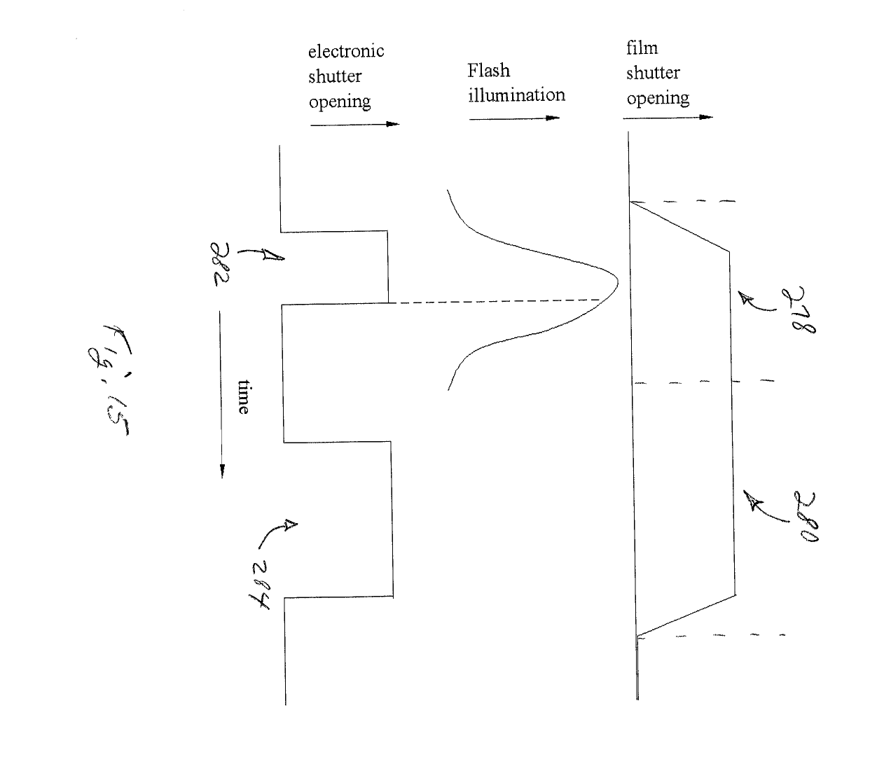

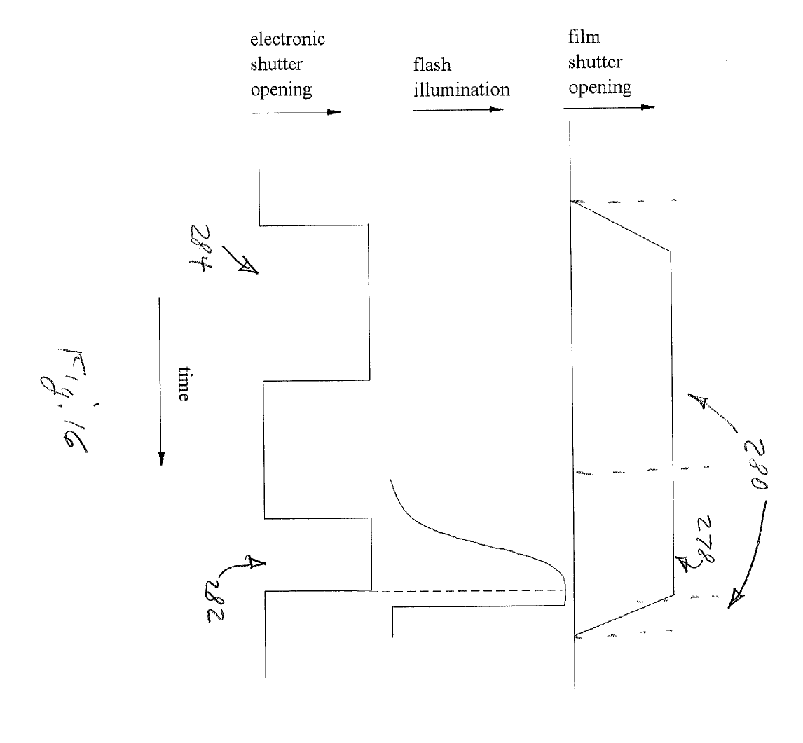

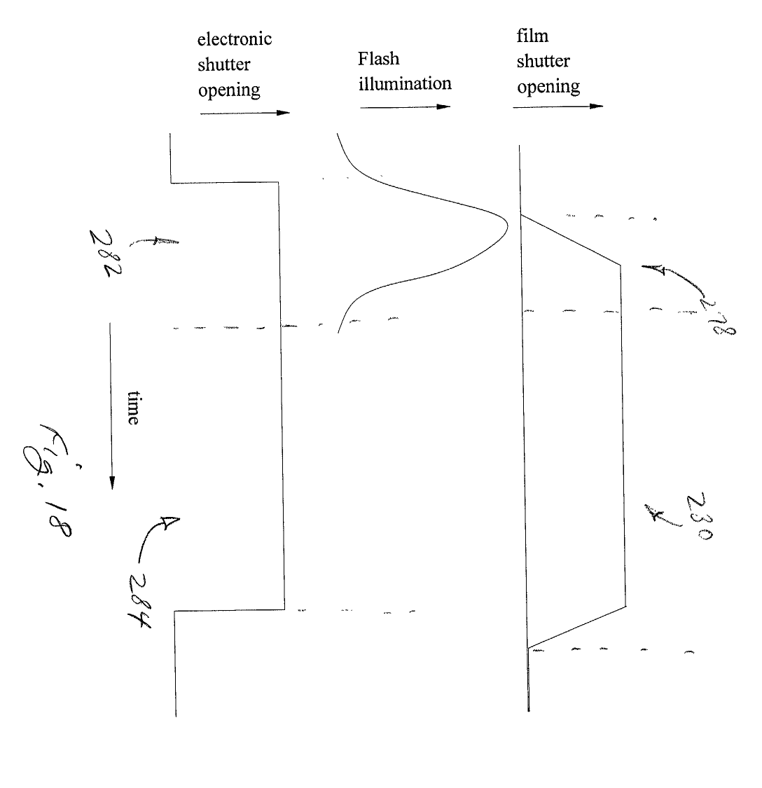

Referring now particularly to FIGS. 1 and 14-18, the four capture events: film flash exposure 278, film nonflash exposure 280, imager flash exposure 282, and imager nonflash exposure 284; result in two or three captured images. One is a latent image on film. The one or two others are electronic images. There is a single electronic image if the imager shutter 110 does not close and reopen between the imager flash exposure and the imager nonflash exposure. Two images are formed when the imager shutter 110 opens and closes between the two exposures and two separate sets of image information are captured. (It is not currently preferred, but a single electronic image can also be provided by some combinations of array imager and physical imager shutter, in which the shutter opens and closes between events, but the captured image charge is accumulated during the multiple exposures to provide a single image.) After capture, the electronic image or images are sent as analog output to the A/D converter-amplifier 120 for conversion to digital electronic images. The first digital electronic image is transferred from the A/D converter 120 and stored in a first memory 122a. The second digital electronic image, if present, is transferred form the A/D converter 120 and stored in a second memory 122b. The electronic images are next transferred from the memories 122a, 122b to the processor 116 through the imager interface 152.

The processor 116 has a combiner 270 that combines the electronic images to provide a resultant electronic image to the processing unit 151. The processing unit 151 further modifies the resultant electronic image as necessary for the requirements of a particular display 26, and outputs the resultant image to the display 26, where the display image produced is seen by the photographer. The combiner 270 can simply add the imager flash exposure and the imager nonflash exposure together on a pixel-by-pixel basis. More complex schemes for combining the two images can be provided, but are not currently preferred. For example, one of the exposure times could be reduced and then the respective exposure values could be biased upward to accommodate the reduction.

The combiner 270 is illustrated as part of the image processor 116. The image processor 116 is also shown as being downstream from the memories. Both of these features are shown in this manner as a matter of convenience for illustration purposes. Connections and usage of the processor 116 and memories 122 need not follow this simplification. The processor 116 and controller 96 are likewise shown as separate components, but could be replaced by a single component providing the same functions.

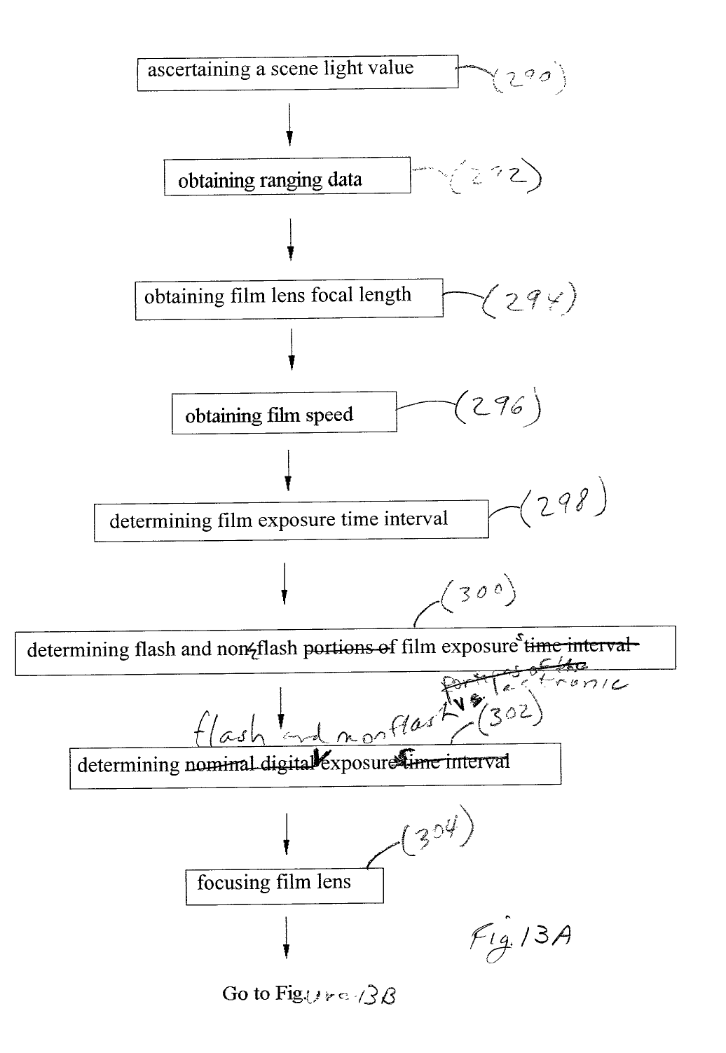

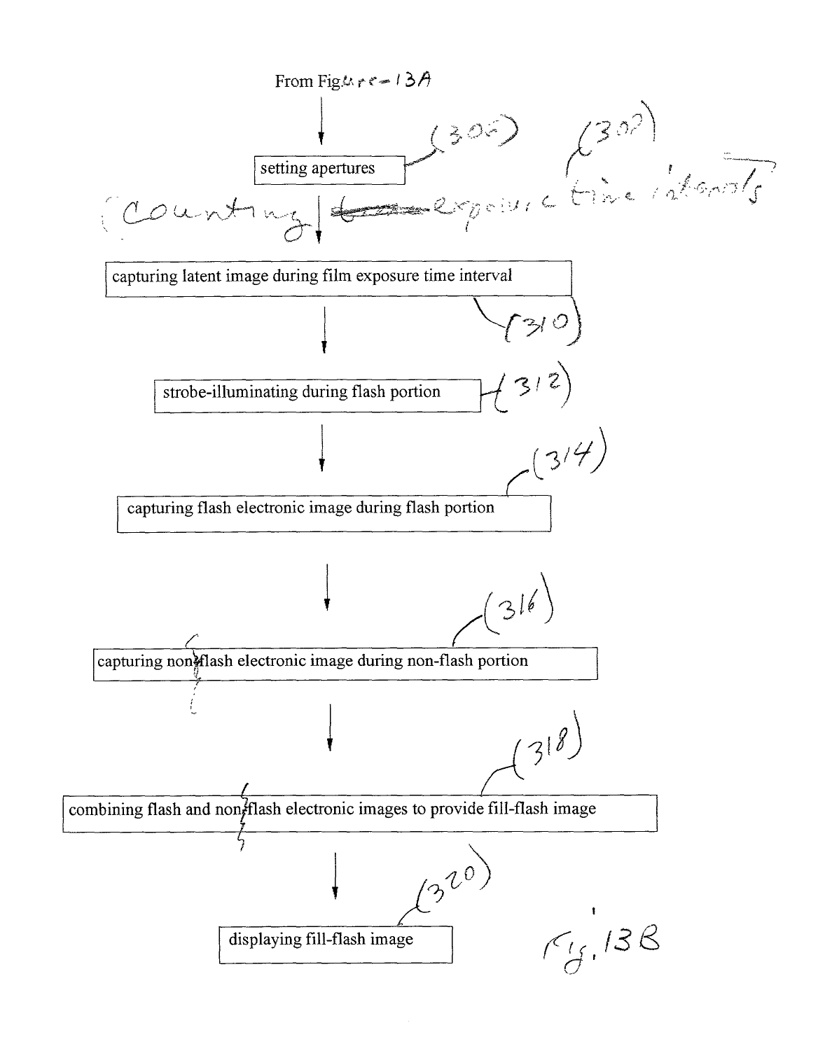

The method of using the just described embodiment of the camera 10 is summarized in FIGS. 13A-13B. The user begins the exposure process by depressing the shutter release through the first stroke. The camera ascertains (290) a scene light value, obtains (292) ranging data, obtains (294) film lens focal length data, and obtains (296) the film speed of the film unit. The camera then determines (298) the film exposure time interval, determines (300) the flash and nonflash film exposures, and determines (302) the flash and nonflash portions of the electronic exposures. The camera focuses (304) the film lens and sets (306) the apertures. The user completes the second stroke and the camera starts counting (308) exposure time intervals. The camera captures (310) the latent film image during the film exposure time interval and flash illuminates (312) during the film flash exposure portion of the film exposure time interval. The camera captures (314) the flash electronic image during the flash illuminating, that is, the flash exposure portion of the film exposure time interval. The camera captures (316) the nonflash electronic image during the nonflash portion of the film exposure time interval. The camera combines (318) the flash and nonflash electronic images to provide a fill-flash image and displays (320) the fill-flash image.

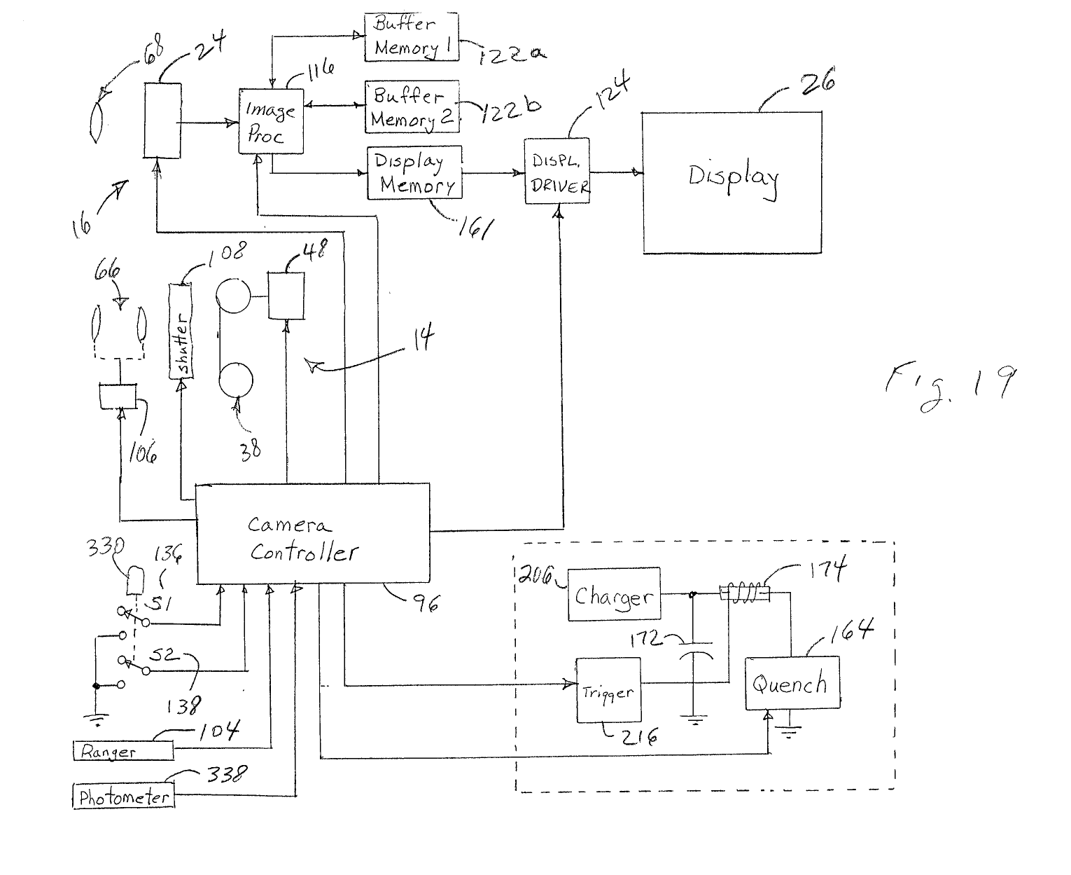

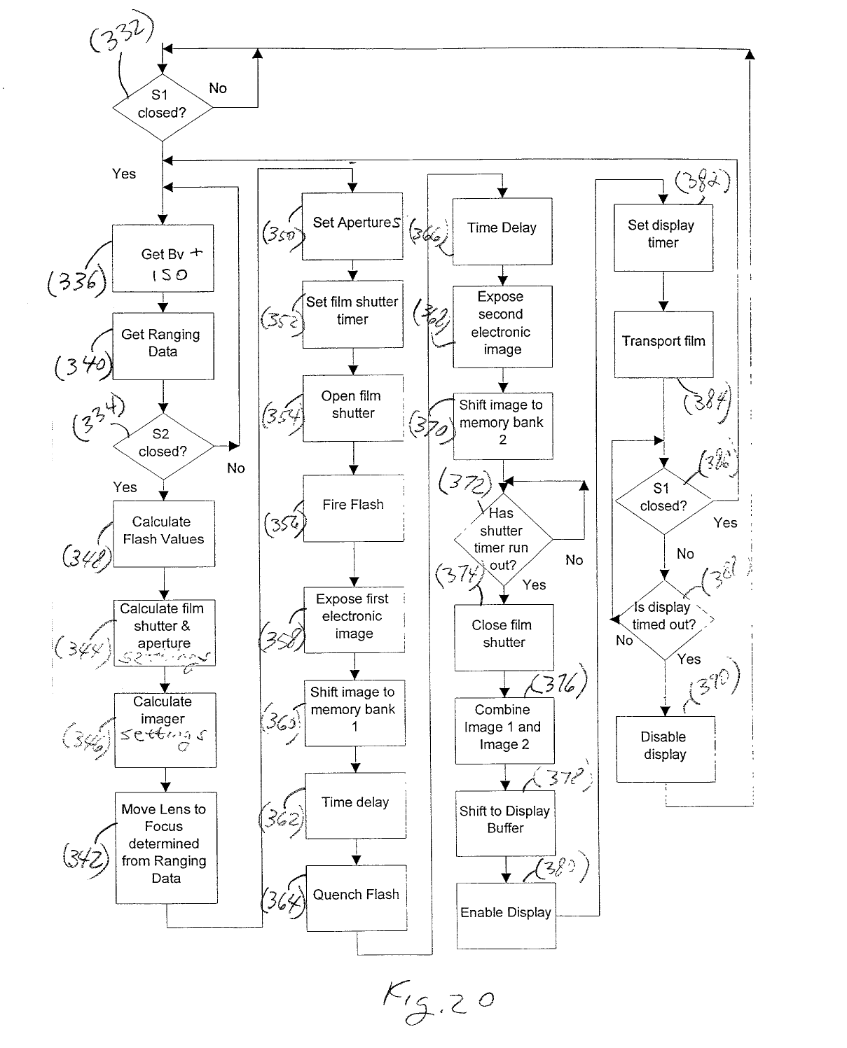

Another embodiment of the invention is illustrated in FIGS. 19-20. Features not described in full detail can be like those earlier described and features of different embodiments can be combined and varied, in a manner well known to those of skill in the art.

Referring now to FIGS. 19-20, the user prepares to take a photograph by partially depressing a button 330 of a shutter release 20. The partial depression of the shutter release button 330 causes a switch 136 (″S1 in FIGS. 19-20) to close. A second switch 138 (S2 in FIGS. 19-20) remains open. A controller 96 looks (332, 334) for closure of switches S1 136 and S2 138. Switch S1 136 closure initializes the camera controller 96. The controller 96 receives (336) an ISO value and/or other parameters of the film read from the film by a film detector disposed in the film space and a brightness value (Bv) from a photometer 338. The controller 96 also receives (340) ranging data from a ranger 104. Based on these values, the controller 96 determines if flash illumination is needed and if the flash is to supplement ambient lighting (fill flash mode) or if the flash is to provide all necessary illumination (full flash mode). If flash illumination is needed, the controller 96 signals a charger 206 to charge a flash capacitor 172 until a maximum or predetermined charge level is reached or for a predetermined time. The controller 96 has a number of internal timers (not separately illustrated in FIG. 19) which time events actuated by the controller 96. As long as switch S1 136 is closed and switch S2 138 is not closed, the camera 10 controller 96 continues to receive updated information and the controller 96 repeatedly updates the camera 10 settings and the determination if flash illumination is needed.

When the shutter release 20 is fully depressed, switch S2 138 is closed, and the controller 96 causes the focus driver to drive (342) the taking lens unit to a position dictated by the ranger 104. The controller 96 calculates (344, 346) film and imager shutter and aperture settings. The controller 96 also calculates (348) the duration of flash illumination during the total film exposure. In a particular embodiment, the controller calculates exposure settings by first calculating the total film exposure, that is, the duration the film shutter 108 is to be open. The controller then calculates the duration of flash illumination. These two calculations define the duration of a film flash exposure and a film nonflash exposure. The controller 96 also calculates a total duration for the electronic imager exposure (flash and nonflash) and the duration of the imager flash exposure, that is, the imager exposure during flash illumination. The difference between these two calculations yields an imager nonflash exposure, which is that portion of the total imager exposure subject only to ambient illumination.

The controller 96 next signals the motor drivers to set (350) apertures, sets (352) an internal timer to delimit the duration of the total film exposure, and signals the film shutter driver (not shown in FIG. 19) to open (354) the film shutter 108 and start timing the duration of total film exposure. A signal is sent from the controller 96 to the trigger circuit 216, which fires (356) the flash lamp 174 discharging the flash capacitor 172. Another timer is started, which delimits the duration of flash illumination. The first electronic exposure is made (358). The electronic exposure is started during the flash illumination and a third timer delimits the duration of imager flash exposure. When the imager flash exposure is completed, the electronic exposure is stopped and the resultant image is shifted (360) to a first buffer memory 122a. After a delay (362), the flash illumination is complete, the flash is turned off (364) by sending a signal to the quench circuit 164. After a further delay (366), the electronic imaging system 16 is actuated (368) for a second electronic exposure. A timer delimits the duration of this imager nonflash exposure. When the imager nonflash exposure is complete, the resultant image is transferred (370) to the second buffer memory 122b. The controller 96 continues to check (372) for when the timer for the total film exposure runs out. When this occurs, the film shutter 108 is closed (374). The images contained in the two buffer memories are combined (376) by the image processor 116 and shifted (378) to the display memory 161. The controller 96 causes the display 26 to be enabled (380) and the display driver 124 causes the image in the display memory 161 to appear on the camera display 26. A timer is set (382) in the controller 96 that delimits the length of time that the display 26 is enabled. The controller 96 also enables the film transport 48 to advance (384) the film to the next film frame 22. If a closure of switch S1 136 is detected (386) or the run of the display timer is completed (388), then the display 26 is disabled (390) and the photographic process is repeated.

The invention has been described in detail with particular reference to certain preferred embodiments thereof, but it will be understood that variations and modifications can be effected within the spirit and scope of the invention.

What is claimed is:

1. A fill-flash hybrid photography method comprising the steps of:
capturing a latent image of a subject on a filmstrip, during a film exposure time interval, said film exposure time interval having a flash portion and a non-flash portion;
strobe-illuminating said subject during said flash portion;
capturing a flash electronic image during said flash portion;
capturing a non-flash electronic image during said non-flash portion;
combining said flash and non-flash electronic images to provide a fill-flash electronic image.

2. The method of claim 1 further comprising displaying said fill-flash image.

3. The method of claim 1 further comprising pausing electronic image capture between said electronic image capture steps.

4. The method of claim 1 wherein said capturing of said flash electronic image precedes said capturing of said non-flash electronic image.

5. The method of claim 1 wherein said strobe-illuminating has a longer duration than said capturing of said flash electronic image.

6. The method of claim 1 wherein said strobe-illuminating includes firing a strobe and quenching said strobe following said firing.

7. The method of claim 6 wherein said quenching is after said capturing of said flash electronic image.

8. The method of claim 1 wherein said non-flash electronic image has at least as long a duration as said flash electronic image.

9. The method of claim 1 wherein said capturing of said latent image and said capturing of one of said electronic images both begin at the same time and said capturing of said latent image and said capturing of the other of said electronic images both end at the same time.

10. The method of claim 1 wherein said capturing of said electronic images has a total duration less than the duration of said flash exposure time interval.

11. The method of claim 1 further comprising determining said film exposure time interval prior to said capturing of said latent image.

12. The method of claim 1 further comprising prior to said capturing steps:
ascertaining a scene light value;
determining said film exposure time interval responsive to said light value; and
determining a nominal electronic image exposure time interval responsive to said light value.

13. The method of claim 12 wherein said capturing of said flash electronic image and said capturing of said non-flash electronic image, added together, have a total duration substantially equal to double said nominal electronic image exposure time interval.

14. The method of claim 13 wherein said electronic images each include a respective set of pixel values; and said combining further comprises:
dividing said pixel values of said flash electronic image by two to provide a first set of halved pixel values;
dividing said pixel values of said non-flash electronic image by two to provide a second set of halved pixel values; and
adding together respective pixel values of said first and second sets of halved pixel values to provide a set of pixel values of said fill-flash electronic image.

15. The method of claim 12 wherein said capturing of said flash electronic image and said capturing of said non-flash electronic image, added together, have a total duration substantially equal to said nominal electronic image exposure time interval.

16. The method of claim 13 wherein said electronic images each include a respective set of pixel values; and said combining further comprises adding together respective pixel values of said sets of pixel values of said flash and non-flash electronic images to provide said set of pixel values of said fill-flash electronic image.

17. A fill-flash hybrid photography method comprising the steps of:
capturing a latent image of a photographic subject;
during a portion of said capturing, strobe-illuminating said subject;
during another portion of said capturing, subjecting said subject to only ambient illumination;
capturing a flash electronic image during said strobe illuminating;
capturing a non-flash electronic image during said subjecting;
combining said flash and non-flash electronic images to provide a fill-flash electronic image; and
displaying said fill-flash electronic image.

18. A fill-flash capable electronic and film camera comprising:
a film capture unit;
an electronic capture unit;
an optical system directing light along a first path to said film capture unit and along a second path to said electronic capture unit;
a film shutter shuttering said first path;
a sensor shutter shuttering said second path;
a flash firing circuit;
a shutter release capable of selectively switching from a set state to a released state;
an actuator operatively connecting said shutter release to said shutters and said flash firing circuit, said actuator, responsive to said switching, momentarily opening said film shutter for a film exposure time interval, said actuator sending a flash start signal and then a flash stop signal through said flash firing circuit during said film exposure time interval, said actuator momentarily opening said sensor shutter a first time after said flash start signal and prior to said flash stop signal to capture a first electronic image, said actuator momentarily opening said sensor shutter a second time after said flash stop signal to capture a second electronic image.

19. The camera of claim 18 further comprising a processor combining said first and second electronic images to provide a fill-flash electronic image and a display showing said fill-flash electronic image following said switching.

20. The camera of claim 19 wherein said sensor shutter is switchable between an open state and a closed state, and said sensor shutter physically blocks said second path in said closed state.
